(19) United States
(12) Patent Application Publication
(10) Pub. No.: US 2018/0040017 A1
(43) Pub. Date: Feb. 8, 2018

(54) System and Method for Improving Marketing Services in a Social Networking Environment

(71) Applicants: Trevor A. Chung, New York, NY (US); Brian I. Chung, Kleinburg (CA)

(72) Inventors: Trevor A. Chung, New York, NY (US); Brian I. Chung, Kleinburg (CA)

(21) Appl. No.: 15/788,707

(22) Filed: Oct. 19, 2017

Related U.S. Application Data
(63) Continuation of application No. 13/786,205, filed on Mar. 5, 2013.

(51) Int. Cl. G06Q 30/02; G06Q 50/00

(52) U.S. Cl. CPC G06Q 30/0242; G06Q 50/01; G06Q 30/0207; G06Q 30/0277

(57) ABSTRACT

A system and method for improving marketing services in a social networking environment are provided. A processor creates and stores data record sections from input data, each having associated metadata associating them with at least one community and at least one associated data record section. Associated data record sections are assembled, and service data records including pages incorporating the input data are generated and stored. A service data record request is received from a device with associated metadata. The processor confirms the request is from a member of the at least one community and the service data record includes only data record sections associated with the at least one community, and responsively transmits the requested service data record to the device to display the pages on the device. A response from the device corresponding to interaction with the series of pages is received and recorded at the memory.

### CROSS REFERENCE TO RELATED APPLICATION

This application is a continuation of U.S. patent application Ser. No. 13/786,205, filed Mar. 5, 2013, titled System and Method for Improving Marketing Services in a Social Networking Environment, which application is incorporated herein in its entirety.

### FIELD OF THE INVENTION

The specification relates generally to computing devices, and specifically to a system and method for improving marketing services in a social networking environment.

### BACKGROUND

When a marketer wishes to provide electronic content to devices, the marketer must generally employ a web developer who designs a webpage, for example, using complicated web development languages, such as HTML (Hypertext Markup Language). When changes to the webpage are desired, the web developer must manually make the change to the webpage and co-ordinate all changes with the design, marketing and programming teams. Hence, the marketer wishing to provide and/or change electronic content must again ask the web developer to make the desired changes using HTML. Further, if the marketer wishes to obtain statistics and/or analytics on content access, the user must request such information from content hosting provider or other service provider. This system is generally inefficient or costly, and leaves the marketer with little or no options of having direct control over their own content and/or analytics regarding the content.

### SUMMARY OF THE INVENTION

A system is provided that comprises a processor, a memory, and a communication interface. The processor is configured to receive, via the communication interface, input data; process the input data to create a plurality of data record sections, where each of the data record sections has associated metadata associating each of the data record sections with at least one community and at least one associated data record section. The processor is further configured to store the plurality of data record sections at the memory; assemble associated data record sections, and generate a plurality of service data records including a series of pages incorporating said input data. The processor is configured to store service data records in memory; receive, via the communication interface, a request for a service data record from a user device together with metadata associated with the user device, confirm that the request is from a member of the at least one community and that the service data record includes only data record sections associated with the at least one community, and responsively transmit the service data record corresponding to the request to the user device via the communication interface to display the series of pages on the user device. The process is also configured to receive, via the communication interface, and record at the memory a response from the user device corresponding to user interaction with the series of pages.

A method is provide that comprises receiving, at a processor via a communication interface, input data; processing, at the processor, the input data to create a plurality of data record sections, where each of the data record sections has associated metadata associating each of the data record sections with at least one community and at least one associated data record section. The method further comprises storing, at a memory, the plurality of data record sections; assembling, at the processor, associated data record sections, and generating a plurality of service data records including a series of pages incorporating said input data. The method also comprises storing, at the memory, the service data records; receiving, via the communication interface, a request for a service data record from a user device together with metadata associated with the user device, confirming, at the processor, that the request is from a member of the at least one community and that the service data record includes only data record sections associated with the at least one community, and responsively transmitting, via the communication interface, the service data record corresponding to the request to the user device to display said series of pages on said user device. The method also comprises receiving, via the communication interface, and recording at the memory, a response from the user device corresponding to user interaction with the series of pages.

In yet another implementation, a computer program is provided, comprising a non-transitory computer usable medium having a computer readable program code adapted to be executed to implement the method described above.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a system for improving marketing services in a social networking environment, according to non-limiting implementations.

FIG. 2 depicts a schematic diagram of a server of the system of FIG. 1, according to non-limiting implementations.

FIG. 3 depicts a schematic diagram of an administrative device of the system of FIG. 1, according to non-limiting implementations.

FIG. 4 depicts a schematic diagram of a publishing device of the system of FIG. 1, according to non-limiting implementations.

FIG. 5 depicts a schematic diagram of a user device of the system of FIG. 1, according to non-limiting implementations.

FIG. 6 depicts a schematic diagram of a data record section of the system of FIG. 1, according to non-limiting implementations.

FIG. 7 depicts associations between the data record sections of the system of FIG. 1, according to non-limiting implementations.

FIG. 8 depicts templates assembled from data record sections in the system of FIG. 1, according to non-limiting implementations.

FIG. 9 depicts assembling of templates data record sections and metadata fields in the system of FIG. 1, according to non-limiting implementations.

FIG. 10 depicts populating of fields of a data record of the system of FIG. 1, according to non-limiting implementations.

FIG. 11 depicts a populated data record of the system of FIG. 1, according to non-limiting implementations.

FIG. 12 depicts generating rendered versions of a data record of the system of FIG. 1, according to non-limiting implementations.

FIG. 13 depicts example rendered versions of a data record of the system of FIG. 1, according to non-limiting implementations.

FIG. 14 depicts views of a graphic user interface of a user device of the system of FIG. 1, according to non-limiting implementations.

FIG. 15 depicts the system of FIG. 1, with a user device requesting a data record, according to non-limiting implementations.

FIG. 16 depicts the system of FIG. 1, with a rendered version of a requested data record being returned to a user device, according to non-limiting implementations.

FIG. 17 depicts the system of FIG. 1, with a device requesting and receiving a rendered version of an analytic data record, according to non-limiting implementations.

FIG. 18 depicts views of a graphic user interface of an example analytic data record, and analytic results, both rendered at a device of the system of FIG. 1, according to non-limiting implementations.

FIG. 19 depicts the system of FIG. 1 with database of data recording interactions between devices and a server, according to non-limiting implementations.

### DETAILED DESCRIPTION

In this specification, elements may be described as “configured to” perform one or more functions or “configured for” such functions. In general, an element that is configured to perform or configured for performing a function is configured to perform the function, or is enabled to perform the function, or is suitable for performing the function, or is adapted to perform the function, or is operable to perform the function, or is otherwise capable of performing the function.

An aspect of the specification provides a system comprising: a processor, a memory, and a communication interface: the processor configured to: receive, via the communication interface, input data; process the input data to create a plurality of data record sections, each of the data record sections having associated metadata associating each of the data record sections with at least one community and at least one associated data record section; store the plurality of data record sections at the memory; assemble associated data record sections, and generate a plurality of service data records including a series of pages incorporating the input data; store the service data records at the memory; receive, via the communication interface, a request for a service data record from a user device together with metadata associated with the user device, confirm that the request is from a member of the at least one community and that the service data record includes only data record sections associated with the at least one community, and responsively transmit the service data record corresponding to the request to the user device via the communication interface to display the series of pages on the user device; and, receive, via the communication interface, and record at the memory a response from the user device corresponding to user interaction with the series of pages.

The processor can be further configured to receive the input data via a template having input fields and the associated metadata corresponds to each of the input fields, the associated metadata defines a type of data received in each of the input fields.

Each of the associated metadata can be configured to provide one or more of: analytics for analyzing interactions with a data record section; format of an output of the input data when the data record sections are rendered in the rendered version of the service data record; relationships with other data record sections; and, data structure of the input data when integrated into the data record section.

The associated metadata can define at least one behaviour of the input data and at least one relationship with other input data.

The processor can be further configured for one or more of: recording activity associated with interactions between the given data record and one or more user devices accessing the data record service via the communication interface; and, analyzing the activity associated with the interactions between the service data record and one or more of the user devices; analyzing the activity associated with the interactions between the service data record and one or more of the user devices based on analytics provided in the associated metadata.

At least one of the data record sections can be configured for building a data record for tracking access of the given data record.

The system can further comprise a content manager configured to control content and assembly of the rendered version of the service data record.

The system can further comprise a compositing engine for producing the rendered version of the given data record.

The system can further comprise a filter configured to provide a subset of rendered data records to one or more user devices when a request for rendered data records is received from one or more of the user devices via the communication interface.

The system can further comprise: an administrator device for configuring one or more of: the data record sections; the one or more metadata fields; the service data records; a content manager configured to control content and assembly of at least a portion of the rendered version of the given data record; and, a filter configured to provide a subset of rendered data records to one or more of user devices when a request for rendered service data records is received from one or more of the user devices via the communication interface; and, at least one publishing device for configuring one or more of: the data record sections; the associated metadata; and the service data record.

Another aspect of the specification provides a method comprising: receiving, at a processor via a communication interface, input data; processing, at the processor, the input data to create a plurality of data record sections, each of the data record sections having associated metadata associating each of the data record sections with at least one community and at least one associated data record section; storing, at a memory, the plurality of data record sections; assembling, at the processor, associated data record sections, and generating a plurality of service data records including a series of pages incorporating the input data; storing, at the memory, the service data records; receiving, via the communication interface, a request for a service data record from a user device together with metadata associated with the user device, confirming, at the processor, that the request is from a member of the at least one community and that the service data record includes only data record sections associated with the at least one community, and responsively transmitting, via the communication interface, the service data record corresponding to the request to the user device to display the series of pages on the user device; and, receiving, via the communication interface, and recording at the memory, a response from the user device corresponding to user interaction with the series of pages.

The input data can be received via a template having input fields and the associated metadata corresponds to each of the input fields, the associated metadata defines a type of data received in each of the input fields.

Each of the associated metadata can be configured to provide one or more of: analytics for analyzing interactions with a data record section; a format of an output of the input data when the data record sections are rendered in the rendered version of the service data record; relationships with other data record sections; and, data structure of the input data when integrated into the data record section.

The associated metadata can define at least one behaviour of the input data and at least one relationship with other input data

The method can further comprise one or more of: recording activity associated with interactions between the given data record and one or more user devices accessing the data record service via the communication interface; analyzing the activity associated with the interactions between the service data record and one or more of the user devices; and, analyzing the activity associated with the interactions between the service data record and one or more of the user devices based on analytics provided in the associated metadata.

At least one of the data record sections can be configured for building a data record for tracking access of the given data record.

The method can further comprise controlling content and assembly of the rendered version of the service data record using a content manager.

The method can further comprise producing the rendered version of the given data record using a compositing engine.

The method can further comprise providing a subset of rendered data records, using a filter, to one or more user devices when a request for rendered data records is received from one or more of the user devices via the communication interface.

The method can further comprise configuring, using an administrator device, one or more of: the data record sections; the one or more metadata fields; the service data records; a content manager configured to control content and assembly of at least a portion of the rendered version of the given data record; and, a filter configured to provide a subset of rendered data records to one or more of user devices when a request for rendered service data records is received from one or more of the user devices via the communication interface; and, at least one publishing device for configuring one or more of: the data record sections; the associated metadata; and the service data record.

Yet a further aspect of the specification provides a computer program product, comprising a computer usable medium having a computer readable program code adapted to be executed to implement a method comprising: receiving, at a processor via a communication interface, input data; processing, at the processor, the input data to create a plurality of data record sections, each of the data record sections having associated metadata associating each of the data record sections with at least one community and at least one associated data record section; storing, at a memory, the plurality of data record sections; assembling, at the processor, associated data record sections, and generating a plurality of service data records including a series of pages incorporating the input data; storing, at the memory, the service data records; receiving, via the communication interface, a request for a service data record from a user device together with metadata associated with the user device, confirming, at the processor, that the request is from a member of the at least one community and that the service data record includes only data record sections associated with the at least one community, and responsively transmitting, via the communication interface, the service data record corresponding to the request to the user device to display the series of pages on the user device; and, receiving, via the communication interface, and recording at the memory, a response from the user device corresponding to user interaction with the series of pages. The computer usable medium can comprise a non-transitory computer usable medium.

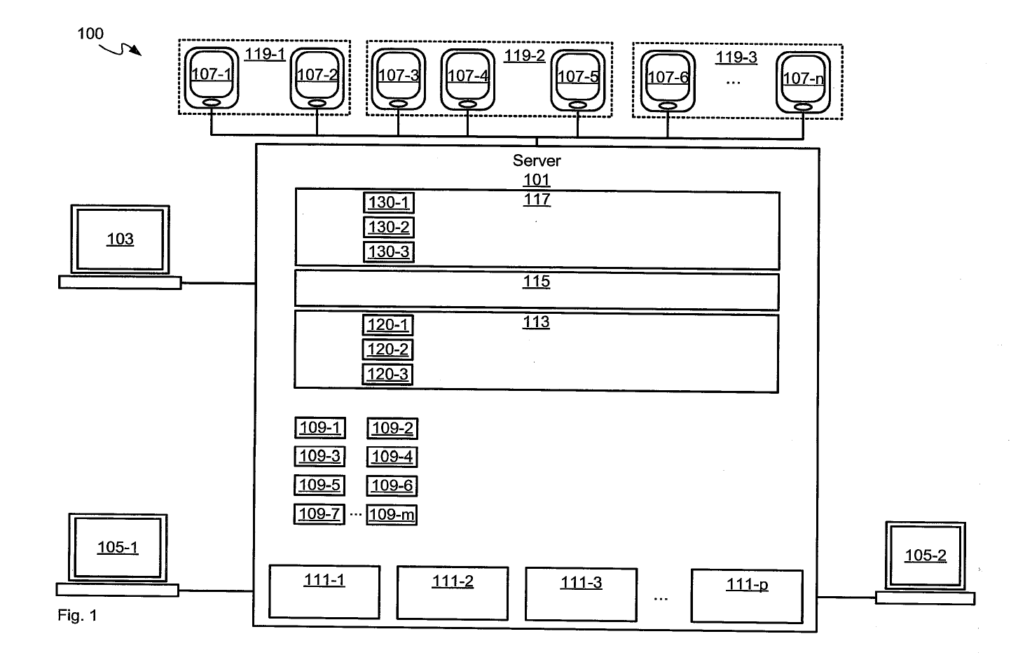

FIG. 1 depicts a system 100 comprising a server 101 configured to communicate with an administration device 103, one or more publishing devices 105-1, 105-2, and user devices 107-1, 107-2, 107-3, 107-4, 107-5, 107-6 . . . 107-n. System 100 further comprises, at server 101, data record sections 109-1, 109-2, 109-3, 109-4, 109-5, 109-6, 109-7 . . . 109-m for building service data records 111-1, 111-2, 111-3 . . . 111-p. One or more publishing devices 105-1, 105-2 will interchangeably be referred to hereafter, collectively, as publishing devices 105, and generically as a publishing device 105. User devices 107-1, 107-2, 107-3, 107-4, 107-5, 107-6 . . . 107-n will interchangeably be referred to hereafter, collectively, as user devices 107, and generically as a user device 107. Data record sections 109-1, 109-2, 109-3, 109-4, 109-5, 109-6, 109-7 . . . 109-m will interchangeably be referred to hereafter, collectively, as data record sections 109, and generically as a data record section 109. Service data records 111-1, 111-2, 111-3 . . . 111-p will interchangeably be referred to hereafter, collectively, as service data records 111, and generically as a service data record 111.

Generally, a service data record 111 presents information to users and allows users to interact with the system 100. The information presented to the user is controlled partly by the system 100 and partly by the type of user, so that the user sees information relevant to the user that has been selected by the publisher of that information. The system 100 controls what information is presented, how that information is presented and how the user can interact with the information.

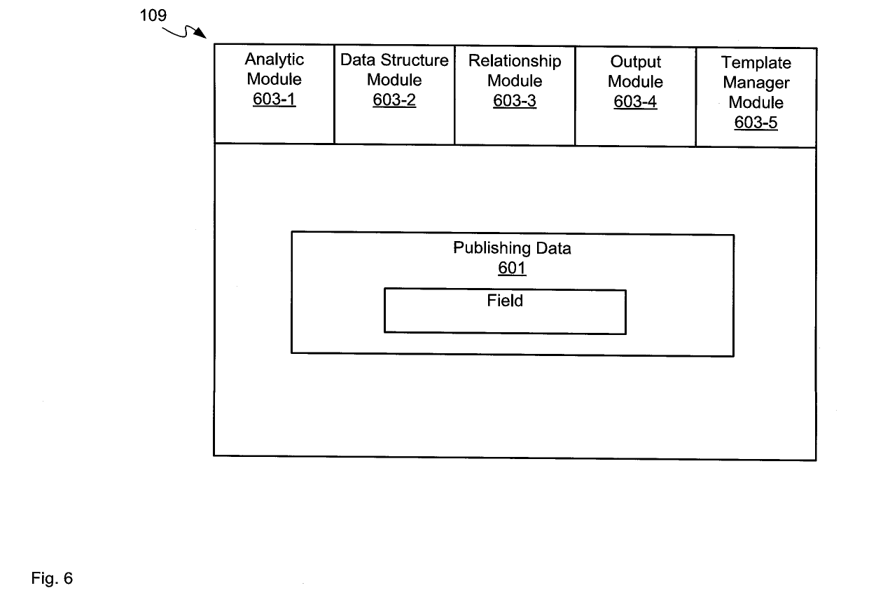

As will be described in further detail below with reference to FIG. 6, each input data block 109 comprises: input data 601, at least a portion of which is configured to be visually provided when a service data record 111 is rendered; and, one or more metadata fields for configuring one or more behaviour of the data record section 109 and relationships with other data record sections 109. Further, server 101 is configured to: receive input data for assembling one or more of the data record sections 109 into a given data record section 111; store the given service data record 111; and, when the given data record is requested by a user device 107, transmit a rendered version of the given service data record 111 to the user device 107.

In depicted implementations, system 100 further comprises: a content manager 113 configured to organize and assemble data record sections 109; a compositing engine 115 for producing the rendered version of the given service data record 111; and, a filter 117 configured to provide a subset of rendered data records 130 to one or more of user devices 107 when a request for rendered data records 130 is received from one or more of the user 107 devices.

Server 101 can be based on any well-known server environment including a module that houses one or more central processing units, volatile memory (e.g. random access memory), persistent memory (e.g. hard disk devices) and network interfaces to allow server 101 to communicate with administrative device 103, publishing devices 105 and user devices 107. For example, server 101 comprise a Sun Fire 8800 series server running a UNIX operating system, from Oracle Corporation, Inc. of Santa Clara Calif., and having eight central processing units each operating at about three thousand megahertz and having more than sixteen gigabytes of random access memory. However, it is to be emphasized that this particular server is merely a non-limiting example, and a vast array of other types of computing environments for servers 101 are contemplated. It is further more appreciated that server 101 can comprise any more than one server that can perform different functionality of server implementations described herein.

It is further appreciated that server 101 is configured to communicate with administrative device 103, publishing devices 105 and user devices 107 over any suitable combination of wired and/or wireless links, wired and/or wireless devices and/or wired and/or wireless networks, including but not limited to any suitable combination of USB (universal serial bus) cables, serial cables, wireless links, cell-phone links, cellular network links (including but not limited to 2G, 2,5G, 3G, 4G+, and the like) wireless data, Bluetooth links, NFC (near field communication) links, WiFi links, WiMax links, packet based links, the Internet, analog networks, the PSTN (public switched telephone network), access points, and the like, and/or a combination.

Further any of server 101, administrative device 103, publishing devices 105 and user devices 107 can be configured to communicate with one or more communication networks, including, but not limited to, wireless networks, wireless networks, cell phone networks, packet based networks, the internet, the PSTN, digital networks, analog networks and the like.

Administrative device 103 can be any type of electronic device that be used in a self-contained manner for configuring one or more of: data record sections 109; service data records 111; the one or more metadata fields of the data record sections 109; content manager 113; and filter 117. It is hence appreciated that administrative device 103 comprises any suitable computing device and/or communication device for communicating with server 101 including but not limited to any suitable combination of computing devices, personal computers, laptop computers, portable electronic devices, mobile computing device, portable computing devices, tablet computing devices, laptop computing devices, desktop phones, telephones, PDAs (personal digital assistants), cellphones, smartphones and the like. Other suitable communication devices are within the scope of present implementations.

It is further appreciated that while only one administrative device 103 is depicted in FIG. 1, system 100 can comprise any number of administrative devices.

Publishing devices 105 can each be any type of electronic device that can be used in a self-contained manner for configuring one or more service data records 111 from one or more of: data record sections 109; service data records 111; the one or more metadata fields of the data record sections 109. It is hence appreciated that publishing devices 105 each comprise any suitable communication device for communicating with server 101. Each publishing device 105 can each include, but is not limited to, any suitable combination of computing devices, personal computers, laptop computers, portable electronic devices, mobile computing device, portable computing devices, tablet computing devices, laptop computing devices, desktop phones, telephones, PDAs (personal digital assistants), cellphones, smartphones and the like. Other suitable communication devices are within the scope of present implementations.

It is further appreciated that while only two publishing device 105 are depicted in FIG. 1, system 100 can comprise any number of publishing devices.

User devices 107 can each be any type of electronic device that can be used in a self-contained manner for requesting rendered versions of service data records 111 from server 101. It is hence appreciated that user devices 107 each comprise any suitable communication device for communicating with server 101. Each user devices 107 can each include, but is not limited to, any suitable combination of computing devices, personal computers, laptop computers, portable electronic devices, mobile computing device, portable computing devices, tablet computing devices, laptop computing devices, desktop phones, telephones, PDAs (personal digital assistants), cellphones, smartphones and the like. Other suitable communication devices are within the scope of present implementations.

It is further appreciated that while only seven user devices 107 are depicted in FIG. 1, system 100 can comprise any number of user devices.

It is yet further appreciated that, in some implementations, user devices 107 can comprise a publishing device 105, and a publishing device 105 can comprise a user device. In other words, each of user devices 107 and publishing devices 105 can play at least a dual role in system 100. Similarly, administrative device 103 can comprise one or more of a publishing device 105 and a user device 107, and vice versa.

It is further appreciated that while, in FIG. 1, administrative device 103 and publishing devices 105 are depicted as desktop computing devices and user devices 107 are depicted as mobile devices, present implementations are not so limiting. Rather, it is appreciated that FIG. 1 is an example only and that each of administrative device 103, publishing devices 105 and user devices can comprise any suitable device as described above.

It is yet further appreciated that each user device 107 is further associated with a community 119-1, 119-2, 119-3, which will interchangeably be referred to hereafter, collectively, as communities 119 and generically as a community 119. For example, user devices 107-1, 107-2 are associated with community 119-1, user devices 107-3, 107-4, 107-5 are associated with community 119-2 and user devices 107-6 . . . 107-n are associated with community 119-3. A community 119 of user devices 107 can be associated via organizational identifiers, institutional identifiers, geographical identifiers, IP (internet protocol) identifiers, and the like, a given identifiers associated with one or more user devices 107.

For example, a community 119 of user devices 107 can be located in the same geographic area, as identified by one or more of geographic identifiers associated with each user device 107 and/or one or more IP or metadata identifiers associated with each user device 107. However, any identifier and/or process can be used to identify a user device 107 as belonging to a specific community 119.

Further, server 101 is further configured to identify with which community 119 a user device 107 is associated; specifically, when server 101 receives a request for data from a given user device 107, server 101 can identify the metadata of the given user device 107, and match the user device 107 with the associated metadata of the community 119.

Further, content manager 113 can comprise community data 120-1, 120-2, 120-3, which is interchangeably referred to hereafter, collectively and generically, as community data 120. Each set of community data 120 comprises metadata for populating metadata fields of data record sections 109 with metadata that is specific to an associated community 119. For example, community data 120-1 can be associated with community 119-1, community data 120-2 can be associated with community 119-2, and community data 120-3 can be associated with community 119-3. Content manager 113 is configured to organize and establish relationship rules for assembling data record sections 109 for ultimately governing the content and appearance of a rendered version of the service data records 111. The organization and relationship rules for each community are stored as metadata in community data 120. Once a particular piece of input data is determined to be associated with a particular community, content manager 113 assigns the metadata from community data 120 to the metadata fields of data record sections 109.

It is further appreciated that community data 120 can be configured and/or provisioned by administrator device 103. Indeed, in some implementations, system 100 can further comprises devices (not depicted), associated with one or more communities 119 for configuring community data 120 specific to a given community 119.

In yet further implementations, publishing devices 105 can configure community data 120, for example publishing devices 105 associated with a given community 119.

Further, community data 120 can be edited and updated as desired by any device configured to edit and/or update community data 120.

Filter 117 comprises data 130-1, 130-2, 130-3, which is interchangeably referred to hereafter, collectively and generically, as data 130. Data 130 comprises data for providing a subset of rendered data records to one or more user devices 107 when a request for rendered data records is received from one or more of user devices 107 via communication interface 228. Data 130 is optimized to minimize the time to upload data 130 from server 101 to the user devices 107. Additionally, filter 117 is configured to undertake a security function to ensure that the user device 107 is registered as a member of the particular community 119 and the extent to which the user device 107 is permitted to utilize the system.

For example, data 130 can comprise data, which defines subsets of service data records 111 (and/or rendered versions thereof) available for retrieval for user devices 107 of each community 119. For example, data 130-1 can be for defining a subset of service data records 111 available to user devices 107 associated with community 119-1, data 130-2 can be for defining a subset of service data records 111 available to user devices 107 associated with community 119-2, and data 130-3 can be for defining a subset of service data records 111 available to user devices 107 associated with community 119-3. For example, data 130-1 can define that service data records 111-1, 111-2 (and/or rendered versions thereof) are available to user devices 107 associated with community 119-1, while data 130-2 can define that service data records 111-3, 111-p (and/or rendered versions thereof) are available to user devices 107 associated with community 119-2, etc.

Data 130 can be configured by any one of administrative device 103, and devices associated with each community 119 (including but not limited to publishing devices 105). In a preferred embodiment, data 130 is a series of pages comprising a front or teaser page, a flip page and one or more detail pages, as discussed hereinafter.

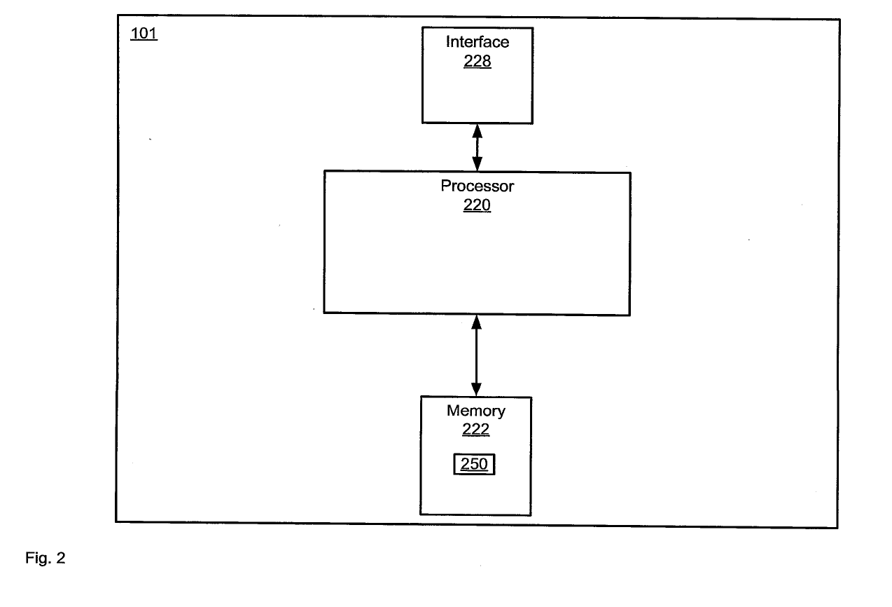

Attention is directed to FIG. 2, which depicts a schematic diagram of server 101 according to non-limiting implementations. It should be emphasized that the structure in FIG. 2 is purely exemplary, and contemplates a server 101 that can be used to assemble service data records 111 from data record sections 109, configure service data records 111, render service data records 111, filter service data records 111, and provide one or more rendered versions of service data records 111 to user devices 107. Server 101 generally comprises a processor 220, a memory 222 and a communication interface 228, interchangeably referred to hereafter as interface 228.

Processor 220 (which can be implemented as a plurality of processors, including but not limited to one or more central processors (CPUs)) is configured to communicate with a memory 222 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 101 as described herein are typically maintained, persistently, in memory 222 and used by processor 220 which makes appropriate utilization of volatile storage during the execution of such programming instructions. Those skilled in the art recognize that memory 222 is an example of computer readable media that can store programming instructions executable on processor 220. Furthermore, memory 222 is also an example of a memory unit and/or memory module.

In particular, it is appreciated that memory 222 stores application 250 that, when processed by processor 220, enables processor 220 to: receive, via interface 228, input data for assembling one or more of the data record sections into a given service data record 111, for example from one or more of administrative device 103 and publishing devices 105; store given service data record 111 at the memory 222; and, when given service data record 111 is requested by a user device 107, transmit a rendered version of given service data record 111 to the user device 107 via communication interface 228.

Interface 228, can be implemented as one or more radios and/or connectors and/or network adaptors, configured to communicate with administrative device 103, publishing devices 105 and user devices 107 via respective links. In general, it will be appreciated that interface 228 is configured to correspond with the network architecture that is used to implement each link, as described above. In other implementations a plurality of links with different protocols can be employed and thus interface 228 can comprise a plurality of interfaces to support each link.

While not depicted, server 101 can further comprise at least one input device and a display.

While not depicted in FIG. 2, it is appreciated from FIG. 1 that server 101 further comprises data record section 109, service data records 111 (when assembled from data record sections 109), content manager 113, compositing engine 115, and filter 117.

While not depicted, it is further appreciated that server 101 comprises a power source, including but not limited to a connection to mains power sources, a battery and/or a power pack, or any other suitable (typically electric) power source.

Further, it should be understood that in general a wide variety of configurations for server 101 are contemplated.

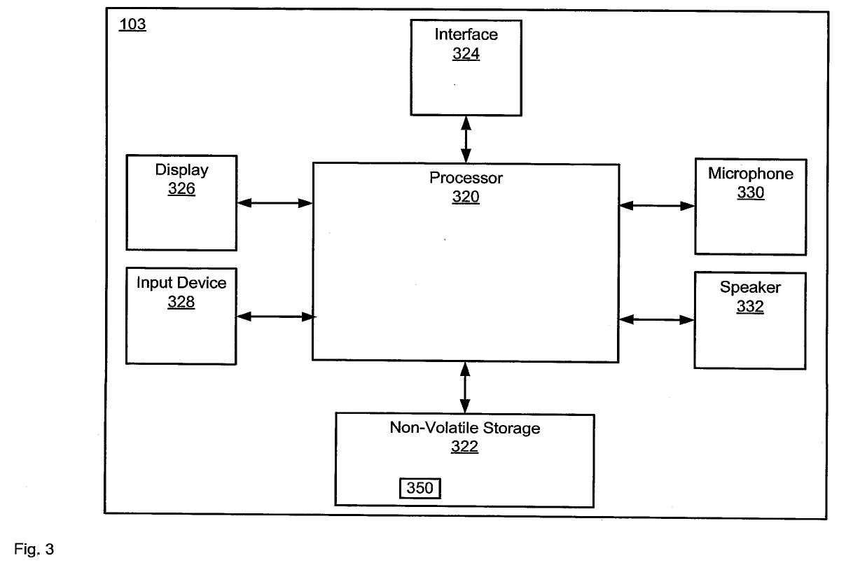

Attention is next directed to FIG. 3, which depicts a schematic diagram of administrative device 103 according to non-limiting implementations. It should be emphasized that the structure of administrative device 103 in FIG. 3 is purely an example, and contemplates a device that can be used to configure elements of server 101. However, in other implementations, administrative device 103 can comprise a device configured for implementing any suitable specialized functions, including but not limited to one or more of telephony, computing, appliance, and/or entertainment related functions.

Administrative device 103 generally comprises a processor 320 interconnected with a memory 322, a communications interface 324, a display 326, and an input device 328 (and optionally a microphone 330 and speaker 332). Communication interface 324 will be interchangeably referred to hereafter as interface 324.

At least one input device 328 is generally configured to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations. In specific non-limiting implementations described herein, input device 328 comprises a touch screen for receiving touch input data.

Input from input device 328 is received at processor 320 (which can be implemented as a plurality of processors, including but not limited to one or more central processors (CPUs)). Processor 320 is configured to communicate with a memory 322 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of administrative device 103 as described herein are typically maintained, persistently, in memory 322 and used by processor 320 which makes appropriate utilization of volatile storage during the execution of such programming instructions. Those skilled in the art recognize that memory 322 is an example of computer readable media that can store programming instructions executable on processor 320. Furthermore, memory 322 is also an example of a memory unit and/or memory module.

In particular, it is appreciated that memory 322 stores application 350 that, when processed by processor 320, enables processor 320 for configuring one or more of: data record sections 109; service data records 111; the one or more metadata fields of the data record sections 109; filter 117; and the community data 120.

It is yet further appreciated that application 350 is an example of programming instructions stored at memory 322.

Processor 320 in turn can also be configured to communicate with display 326, and optionally microphone 330 and a speaker 332. Display 326 comprises any suitable one of or combination of CRT (cathode ray tube) and/or flat panel displays (e.g. LCD (liquid crystal display), plasma, OLED (organic light emitting diode), capacitive or resistive touch screens, and the like). When display 326 comprises a touch screen, it is appreciated that display 326 and input device 328 are combined into one apparatus. Microphone 330, when present, comprises any suitable microphone for receiving sound and converting the sound to sound data. Speaker 332, when present, comprises any suitable speaker for providing sound data, audible alerts, audible communications from remote communication devices, and the like, at administrative device 103.

In some implementations, input device 328 and display 326 are external to administrative device 103, with processor 320 in communication with each of input device 328 and display 326 via a suitable connection and/or link.

Processor 320 also connects to interface 324, which can be implemented as one or more radios and/or connectors and/or network adaptors, configured to communicate with network 105 via link 140. In general, it will be appreciated that interface 324 is configured to correspond with the network architecture that is used to implement link 140, as described above. In other implementations a plurality of links with different protocols can be employed and thus interface 324 can comprise a plurality of interfaces to support each link.

While not depicted, it is further appreciated that administrative device 103 comprises a power source, including but not limited to a connection to mains power sources, a battery and/or a power pack, or any other suitable (typically electric) power source.

In any event, it is appreciated that any suitable combination of interfaces is within the scope of present implementations.

Further, it should be understood that in general a wide variety of configurations for administrative device 103 are contemplated.

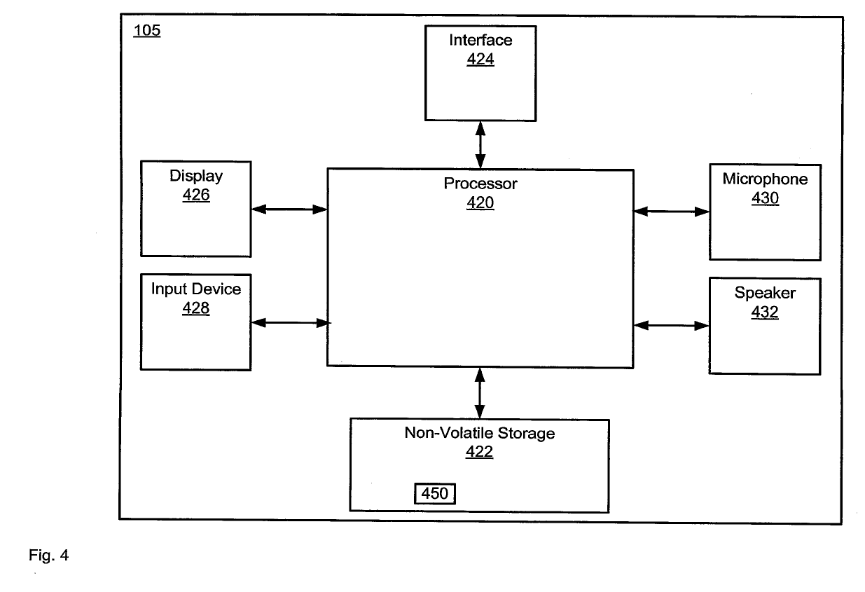

Attention is next directed to FIG. 4, which depicts a schematic diagram of publishing devices 105 according to non-limiting implementations. It is appreciated that each publishing device 105 can be substantially similar to, or different from, administrative device 103. In any event, FIG. 4 is substantially similar to FIG. 3, with like elements having like numbers, however preceded by a “4” rather than a “3”; for example, processor 420 is substantially similar to processor 320. Specifically, each publishing device 105 generally comprises a processor 420 interconnected with a memory 422, a communications interface 424, a display 426, and an input device 428 (and optionally a microphone 430 and speaker 432). Communication interface 424 will be interchangeably referred to hereafter as interface 424. In particular, it is appreciated that memory 422 stores application 450 that, when processed by processor 420, enables processor 420 for configuring one or more of: data record sections 109; service data records 111; and the one or more metadata fields of the data record sections 109.

It should be emphasized that the structure of publishing device 105 in FIG. 4 is purely an example, and contemplates a device that can be used to configure elements of server 101. However, in other implementations, publishing device 105 can comprise a device configured for implementing any suitable specialized functions, including but not limited to one or more of telephony, computing, appliance, and/or entertainment related functions.

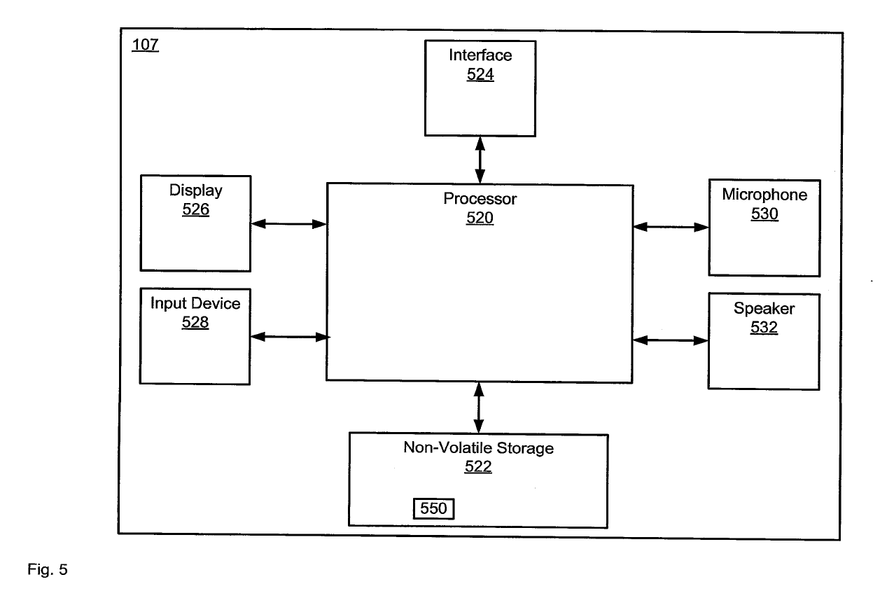

Attention is next directed to FIG. 5, which depicts a schematic diagram of user devices 107 according to non-limiting implementations. It is appreciated that each user device 107 can be substantially similar to, or different from, administrative device 103 and/or publishing devices 105. In any event, FIG. 5 is substantially similar to FIG. 4, with like elements having like numbers, however preceded by a “5” rather than a “4”; for example, processor 520 is substantially similar to processor 320. Specifically, each user device 107 generally comprises a processor 520 interconnected with a memory 522, a communications interface 524, a display 526, and an input device 528 (and optionally a microphone 530 and speaker 532). Communication interface 524 will be interchangeably referred to hereafter as interface 524. In particular, it is appreciated that memory 522 stores application 550 that, when processed by processor 520, enables processor 520 to request and receive rendered versions of service data records 111.

It should be emphasized that the structure of user device 107 in FIG. 5 is purely an example, and contemplates a device that can be used to interact with server 101. However, in other implementations, user device 107 can comprise a device configured for implementing any suitable specialized functions, including but not limited to one or more of telephony, computing, appliance, and/or entertainment related functions.

In some implementations, server 101, administrative device 103, publishing devices 105 and user devices 107 can operate in a client-server environment. In other implementations server 101, administrative device 103, publishing devices 105 and user devices 107 can operate in browser type environment, with data being exchanged between server 101, administrative device 103, publishing devices 105 and user devices 107 using, for example, any suitable packet-based protocol. In yet further implementations, administrative device 103 and publishing devices 105 can download data from server 101 for editing locally and upload edited data to server 101. Indeed, the environment in which server 101, administrative device 103, publishing devices 105 and user devices 107 is generally appreciated to be non-limiting.

Attention is next directed to FIG. 6, which depicts a schematic diagram of a data record section 109. Each data record section 109 comprises input data 601 and associated metadata at least a portion of the input data 601 is configured to be visually provided when a service data record 111 is rendered. Input data 601 is associated with one or more fields 603 for receiving metadata configurable by an administrative device 103 or a publishing device 105 via the content manager 113. Input data 601 includes text data to be rendered as text or copy in the rendered version of a given service data record 111; graphical or image data to be rendered as graphics, foreground or background, in the rendered version of a given service data record 111; and, numerical data to be rendered in the rendered version of a given service data record 111.

Hence, for example input data 601 can comprise one or more of types of data to be published, text to be published, a file to be published, a graphical file to be published, and the like. Indeed, as depicted, input data 601 comprises data to be published, for example, from one or more publishing devices 105. For example, input data 601 can be a name of a business and/or an event, hours for the business and/or the event, a cost associated with the business and/or the event (including, but not limited to, a cost of goods and/or services associated with the business), a telephone number associated with the business and/or the event, and the like.

Input data 601 also can comprise active elements, including, but not limited to virtual buttons which can be used to initiate an action when actuated. Such virtual buttons, and/or other active elements, can be configured with actions that are to occur when the virtual button is actuated, for example retrieval of given data from server 101. Such actions can be specified in an appropriate metadata field, as described hereafter.

Each data record section 109 further comprises one or more metadata fields 603-1, 603-2, 603-4, 603-5 for associating metadata to configure one more of behaviour of a respective data record section 109 and relationships with other data record sections 109. Metadata fields 603-1, 603-2, 603-4, 603-5 will interchangeably be referred to hereafter, collectively, as metadata fields 603, and generically as a metadata field 603. Each metadata field 603 can be configured to provide one or more of: analytic metadata field 603-1 for analyzing interactions with a respective data record section 109; data structure metadata field 603-2 for defining a data structure of input data 601; relationship metadata field 603-3 for defining relationships with other data record sections 109 and service data records 111; output metadata field 603-4 for defining a format of an output of a respective data record section 109 when the respective data record section 109 is rendered in a rendered version of a given service data record 111; and workflow metadata field 603-5 for defining scheduling of processing for data record section 109 to assemble a service data record 111.

While only five metadata fields 603 are depicted in FIG. 6, it is appreciated that a data record section 109 can comprise any number of metadata fields 603. Any number of metadata fields 603 can be added to system 100 by administrative device 103 via content manager 113, and further each metadata field 603 can be configured by administrative device 103, via content manager 113. Indeed, administrative device 103 can add metadata fields 603 to and/or remove metadata fields 603 from a given data record section 109 via interactions between administrative device 103 and server 101. For example, server 101 can store one or more metadata fields 603 in a library, database, and the like, of metadata fields 603 and can add metadata fields 603 to (and/or remove metadata fields 603 from) a given data record section 109 based on features that a given data record section 109 is to have.

Hence, it is yet further appreciated that each metadata field 603, and input data 601, data record sections 109, as well as service data records 111, can be configured using object-oriented techniques such that data record sections 109 can be assembled from input data 601 and metadata fields 603, and service data records 111 can be assembled from data record sections 109 using techniques that do not require further programming at a device which is causing data record sections 109 and/or service data records 111 to be assembled. For example, graphical techniques can be used to assemble both of data record sections 109 and service data records 111, including, but not limited to, drag and drop techniques and the like.

Analytic metadata field 603-1 can comprise metadata configured for counting a number of times that a data record section 109 is accessed; in other words, each time a service data record 111 which comprises associated metadata in the analytic metadata field 603-1 is accessed (and/or a rendered version thereof) processor 220 of server 101 stores, at memory 222, a record of the access.

Alternatively, metadata in the analytic metadata field 603-1 cooperates with a tool which further causes processor 220 of server 101 to record an identifier of a user device 107 which accesses a service data record 111 which comprises analytic metadata field 603-1 is accessed (and/or a rendered version thereof).

Indeed, analytic metadata field 603-1 can comprise any metadata tool that provides analytics of associated data record sections 109 and/or associated service data records 111. Alternatively, system 101 can comprise a plurality of analytic metadata fields 603, each analytic metadata field 603 comprising a tool that provides respective analytics.

Regardless of whether system 101 comprises a multifunctional analytic metadata field 603 and/or a plurality of specialized analytic metadata fields 603, access of a service data record 111 (and/or a rendered version thereof) comprising one or more analytic metadata fields 603 by a user device 107 causes processor 220 to perform the associated analytics. In this manner, processor 220 is configured to track and/or record activity at and/or interactions with server 101, including, but not limited to access of specific service data records 111. The interactions can be related to viewership, usage, behaviour patterns; user's understanding of the marketing and user's actions i.e. redemptions.

For example, by processing one or more analytic metadata fields 603, processor 220 can be configured for one or more of: recording activity associated with interactions between a given service data record 111 and one or more user devices 107 accessing the given service data record 111 via communication interface 228; analyzing the activity associated with the interactions between the given service data record 111 and one or more of user devices 107; analyzing activity associated with the interactions between the given service data record 111 and one or more of user devices 107 based on analytics provided in one or more of the metadata fields 603.

Data structure metadata field 603-2 generally comprises associated metadata for defining data structure of a data record section 109, including, but not limited to, data structure of input data 601. For example, data structure metadata field 603-2 can define a size of input data 601, a format of input data 601, and/or, in some implementations, where to store input data 601 at memory 222 (e.g. a memory location, a database location (using, for example, a database identifier), and the like), and the like.

It is further appreciated that value of metadata at data structure metadata field 603-2 can be configured by one or more of administrator device 103 and one or more publishing devices 105.

Relationship metadata field 603-3 generally comprises associated metadata for defining relationships and rules between data record sections 109 and service data records 111. For example, associations between data record sections 109 can be related via relationship metadata field 603-3, and indeed, relationship metadata field 603-3 can define associations between a given data record section 109 and other data record sections 109; however an associations between a first data record section 109 and other data record sections 109 can be different than associations between a second data record section 109 and other data record sections 109. In other words, relationship metadata field 603-3 can be configured for a given data record section 109 and/or different subset of data record sections 109 can be associated via respective relationship metadata fields 603-3.

Alternatively, relationship metadata field 603-3 can comprise one or more metadata identifiers for identifying a data record section 109 as being a member of a particular community 119, which metadata identifiers are received from the community data 120.

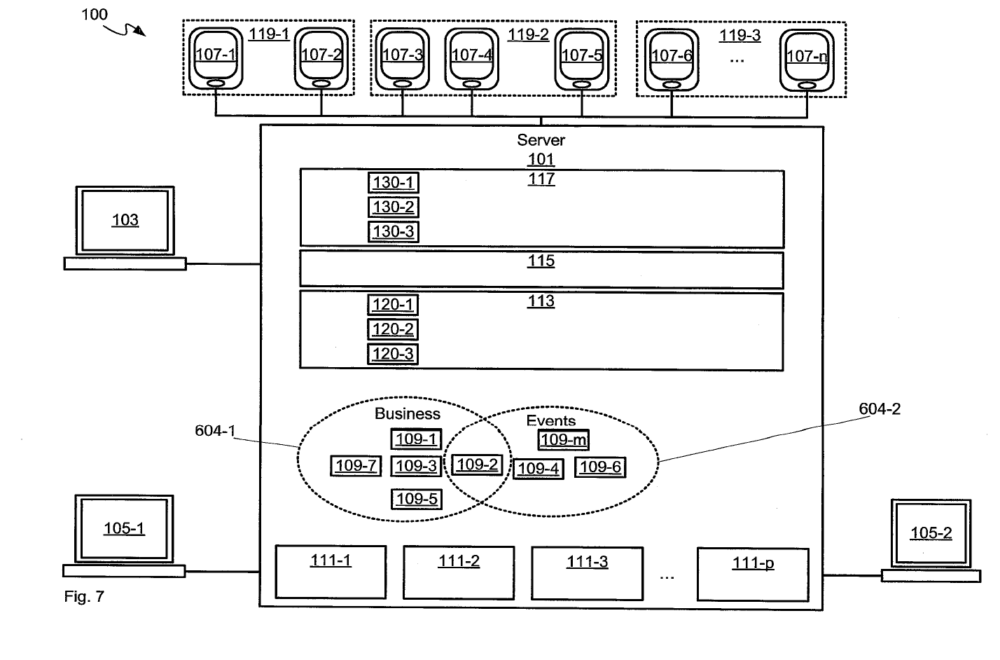

A non-limiting example of data record sections 109 being related via metadata is depicted in FIG. 7, which is substantially similar to FIG. 1, with like elements having like numbers. In the depicted example, data record sections 109-1, 109-2, 109-3, 109-5, 109-7 each comprise a relationship metadata field 604-1 that associates them with each other, for example, using a “Business” identifier; similarly, data record sections 109-2, 109-4, 109-6, 109-m each comprise a relationship metadata field 604-2 that associates them with each other, for example, using an “Event” identifier. While the associations are depicted in FIG. 7 via broken lines around associated data record sections 109, it is appreciated that the associations are actually performed using relationship metadata fields 603-3.

Indeed, any type of identifier can be used to associate data record sections 109. For example, in some implementations, data record sections 109 can be associated with a given community 119.

Further, it is appreciated that block 109-2 is associated with both subsets of data record sections 109, as also indicated using a relationship metadata field 603-3.

Referring back to FIG. 6, output metadata field 603-4 generally comprises associated metadata for defining a format of output of a data record section 109, for example, a font type, a font size, a graphics resolution, whether input data 601 is to be in a foreground and/or a background and the like. Output metadata field 603-4 can comprise metadata for defining how input data 601 is to appear in a rendered version of a service data record 111. Additionally, the metadata of output metadata field 603-4 can regulate position on the display page and position relative to other input data. For example, a logo may be required to be positioned to the left of a business name.

Workflow manager metadata field 603-5 generally comprises associated metadata for defining a sequence and schedule that a data record section 109 is to be processed.

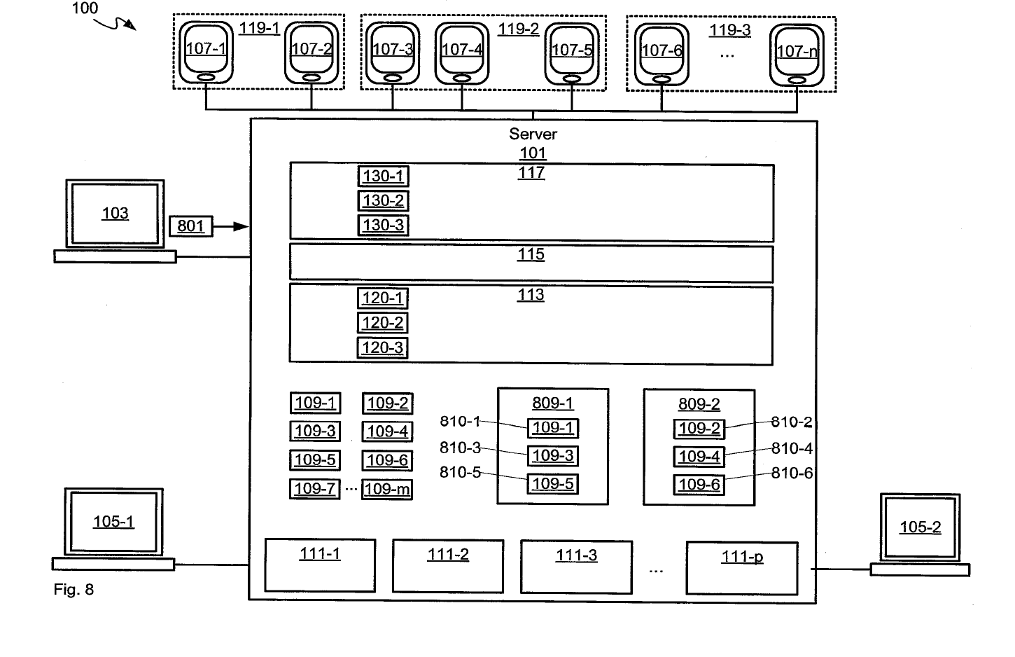

Referring to FIG. 8, administrative device 103 assembles selected data record sections 109 into a service data record 111. FIG. 8 is substantially similar to FIG. 1, with like elements having like numbers. However, in FIG. 8, administrative device 103 is communicating with server 101 via commands 801 to assemble templates 809-1, 809-2, templates 809-1, 809-2 interchangeably referred to hereafter as templates 809 and, generically, as a template 809. Further, while only two templates 809 are depicted in FIG. 8, present implementations comprise any number of templates 809.

Each template 809 is provided with a plurality of data fields 810. Each field 810 corresponds to a data record section 109. Each field 810 is configured to receive input data 601 and content manager 113 initially assigns and populates the metadata fields 603 with associated metadata that is common to the template 809 and specific to each field 810. For example, template 809-1 could be configured to receive general information, e.g. 810-1: “business name: 810-3: “business address”, and 810-5: “telephone number”, etc. Template 809-1 is configured to assign metadata to each input data that will: identify whether the data record section is to be counted, and if so how it is to be counted, for analytic field 603-1; identify the type of data for the data structure field 603-2; relate the “business address” and “telephone number” to the “business name” for relationship field 603-3; identify output formats for output field 603-4; and identify uses as a data record section 109 for assembling service data records 111 for workflow field 603-5. Similarly, template 809-2 could be configured to receive product information, e.g. 810-2: “product name”; 810-4: “product description”; and 810-6: “product logo”. Hence, each template 809 is configured to assign metadata to the metadata fields 603 of the data record sections 109.

Examples of data record sections 109 include: Postcards, Menus, Locations, Hours of Operation, Contact, About Us, Contact Us, Events, Legal, Weather, Share, Review, Social Media, Sponsors, Nutritional Content, Promotion, Weekly Specials and a General section.

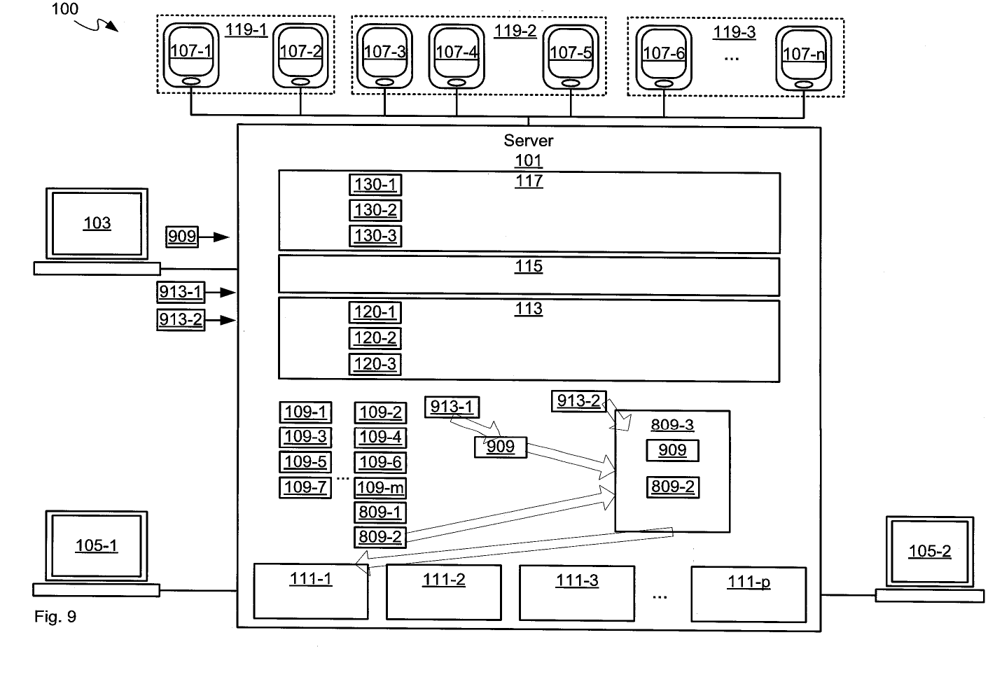

Attention is next directed to FIG. 9, which depicts a provisioning process for system 100. Administrative device 103 uploads a data record section 909 to server 101, data record section 909 being substantially similar to data record sections 109, including metadata fields 913, being similar to metadata fields 603 (metadata fields 913-1, 913-2 will interchangeably be referred to hereafter, collectively, as metadata fields 913 and generically as a metadata field 913). Indeed, it is appreciated that each data record section 109, 909 and each metadata field 603, 913 can be uploaded to server 101 from administrative device 103 (and alternatively, a publishing device 105). In other words, data record sections 109, 909 and metadata fields 603, 913 can be developed external to server 101, and indeed external to system 100, and uploaded thereto.

In any event, metadata fields 913 (and/or any other metadata fields 603) can then be added to any of data record sections 109; as depicted, administrative device 103, interacting with server 101, for example, in a client-server environment, can cause metadata field 913-1 to be added to data record section 109. Similarly, administrative device 103 can cause a template 809-3 to be generated, and both metadata field 913-2 and data record section 909 can be added thereto. Further data record sections 109, 909 and/or templates 809 can be added to template 809-3, such as data record section 909 and template 809-2. As such, metadata fields 603 for each of data record section 909 and template 809-2 are added to template 809-3, in addition to metadata field 913-2. Each metadata field 603, 913 can, however, remain associated with a respective data record section 109, 909 and/or template 809 even when a respective data record section 109, 909 and/or template 809 is added to template 809-3.

It is yet further appreciated that when template 809-3 is generated and a template type of template 809-3 is identified, for example using metadata field 913-2, data record sections 109, 909 that have a defined relationship with the template type, for example as defined by relationship metadata field 603-3, can be made available to administrative device 103 for adding to template 809-3; other data record sections 109 can be blocked from being added to template 809-3.

Template 809-3 and/or any other template 809 and/or any other data record section 109, 909 can then be assembled into a service data record 111, such as service data record 111-1, which comprises template 809-3. Alternatively, input data 601 can be assembled through template 809-3 to generate service data record 111-1.

The assembling of input data 601 and metadata 603, 913 into data record sections 109, assembling of data record sections 109 into service data records 111 and/or populating of fields 810 of template 809 can occur using any suitable user interface, including, but not limited to, one or more of a command line interface, a graphical user interface, a drag and drop interface, and the like.

It is yet further appreciated that administrative device 103 can further populate fields 810 with input data 601 in one or more data record sections 109, 909, prior to template 809-3 being assembled. For example, a background or other graphics files can be uploaded to server 101 and added to a field 810 of a template 809 that populates a data record section 109 destined as a background or other graphics for a rendered version of service data record 111.

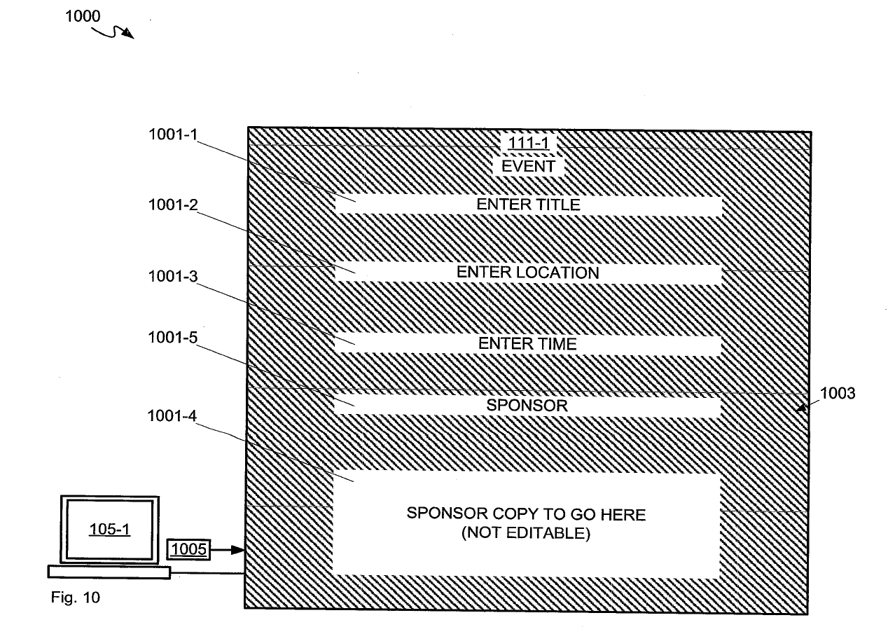

In any event, attention is next directed to FIG. 10 which depicts a Graphic User Interface (GUI) 1000 for generating and/or populating a data record section 109 or a service data record 111-1. For example, GUI 1000 can be provided at display 426 of a publishing device 105, for example publishing device 105-1. However, when publishing devices 105 and server 101 are operating in a client-server environment, GUI 1000 can be generated at server 101 and accessed by publishing device 105-1 via the link therebetween. In any event, publishing device 105-1 is also depicted in FIG. 10 as being in “communication” with GUI 1000, though it is appreciated that that publishing device 105-1 is in communication with a device that is generating GUI 1000. When GUI 1000 is generated at publishing device 105-1, it is appreciated that communications with GUI 1000 are internal to publishing device 105-1.

It is further appreciated that publishing device 105-1 can access templates 809 using a user interface for selecting templates for editing and/or conversion to data records, selecting existing data record sections 109 or service data records 111 for editing, and the like. It is further assumed in FIG. 10 that template 809-3 has been selected to generate service data record 111-1.

GUI 1000 comprises fields 1001-1, 1001-2, 1001-3, 1001-4, 1001-5 (interchangeably referred to hereafter collectively as fields 1001 and generically as a field 1001) corresponding to fields 810 of template 809-3, for example data record sections 109-2, 109-4, 109-6, 909. However not all fields 810 of data record sections 109-2, 109-4, 109-6, 909 need to have a counterpart in GUI 1000. For example, as described above, a background 1003 of GUI 1000 can already have been provided at template 809-3 by administrative device 103 uploading a graphics file to server 101 and populating a field 810 of a background data record section 109 with the graphics file.

Each field 1001 can further comprise initial text data overlay, which indicates a type of data to be received at each field 1001 (e.g. “ENTER TITLE”, “ENTER LOCATION”, “ENTER TIME”, “SPONSOR”).

However, not all fields 1001 are necessarily editable via a publishing device 105. For example, field 1001-4 can comprise a field that can be configured such that service data record 111 can be configured for different communities 119, as described below. In these implementations, field 1001-4 further comprises text which indicates such (“SPONSOR COPY TO GO HERE (NOT EDITABLE)”).

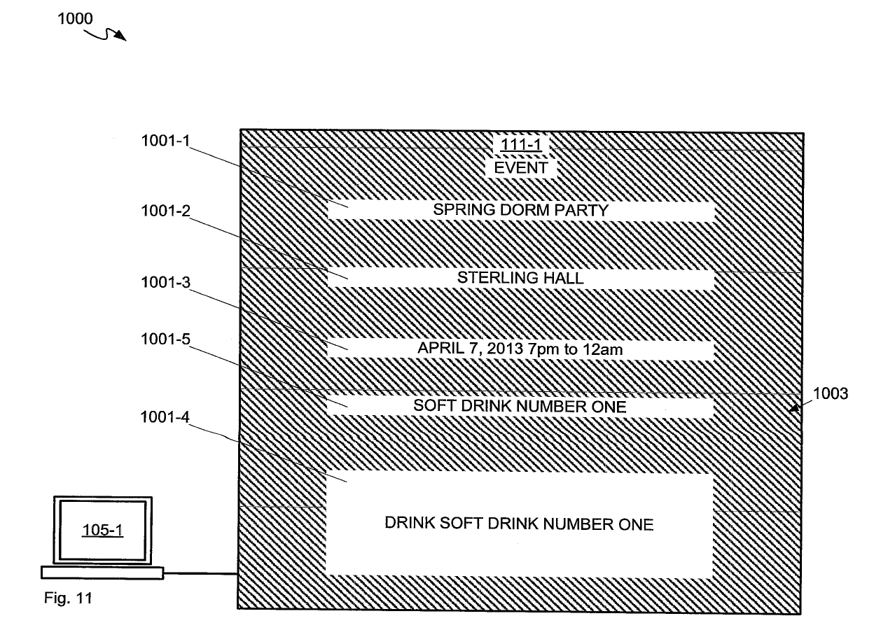

In any event, publishing device 105-1 can receive input data 1005 at input device 428 for populating fields 1001, and input data 1005 is used to populate fields 1001, as depicted in FIG. 11, which is substantially similar to FIG. 10, with like elements having like numbers. In these implementations, fields 1001-1, 1001-2, 1001-3 have been populated with text data received in input data 1005. Processor 220 at server 101 determines whether the text input data 1005 is compatible with a given field 1001 and provides warnings, notifications and the like if not (e.g. date and/or time data in field 1001-3 can be restricted to date and/or time formats, and/or a limit can be placed on size of text data in each field).

Once each of the fields 1001 has been entered, data record section 109 will be assembled and thereafter a service data record 111-1 will be assembled and stored at server 101. Once a predetermined number of service data records have been stored, a rendered version of service data record 111-1 can be generated by compositing engine 115.

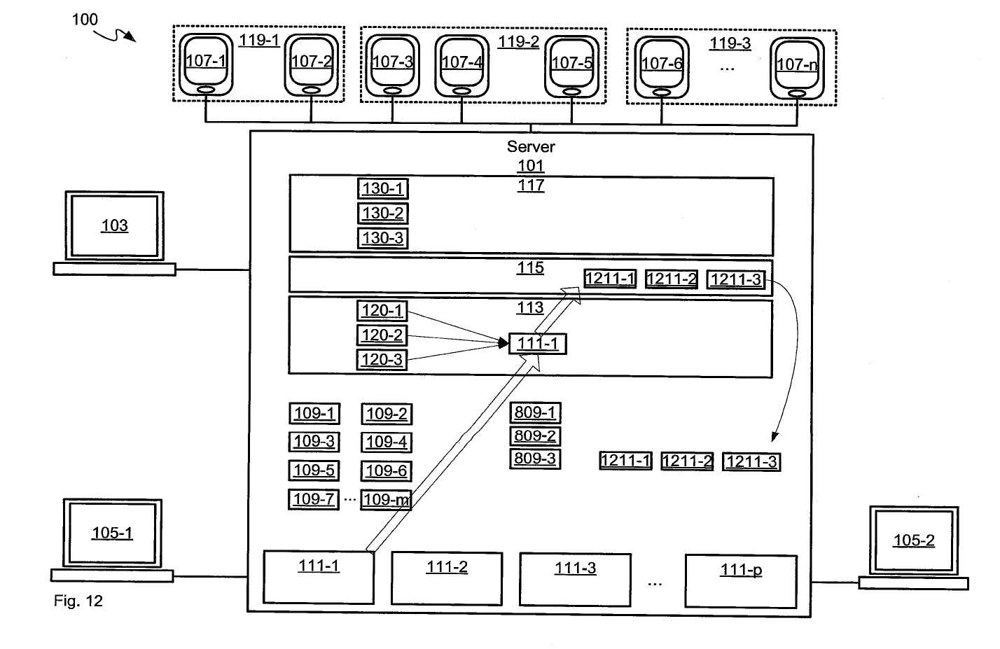

In some implementations, when a given service data record 111 is generated and/or updated and/or edited, processor 220 generates different rendered versions of the given service data record 111 specific to each community 119. As depicted in FIG. 12, which is substantially similar to FIG. 9 with like elements having like numbers, each set of community data 120 is used to populate field 1001-4 rendered versions 1211-1, 1211-2, 1211-3 of service data record 111-1, each rendered version 1211-1 similar to GUI 1001 described above but with field 1001-4 configured specific to an associated community 119. Rendered versions 1211-1, 1211-2, 1211-3 will interchangeably referred to hereafter, collectively, as rendered versions 1211 and generically as a rendered version 1211. Further rendered versions 1211 are generated by compositing engine 115.

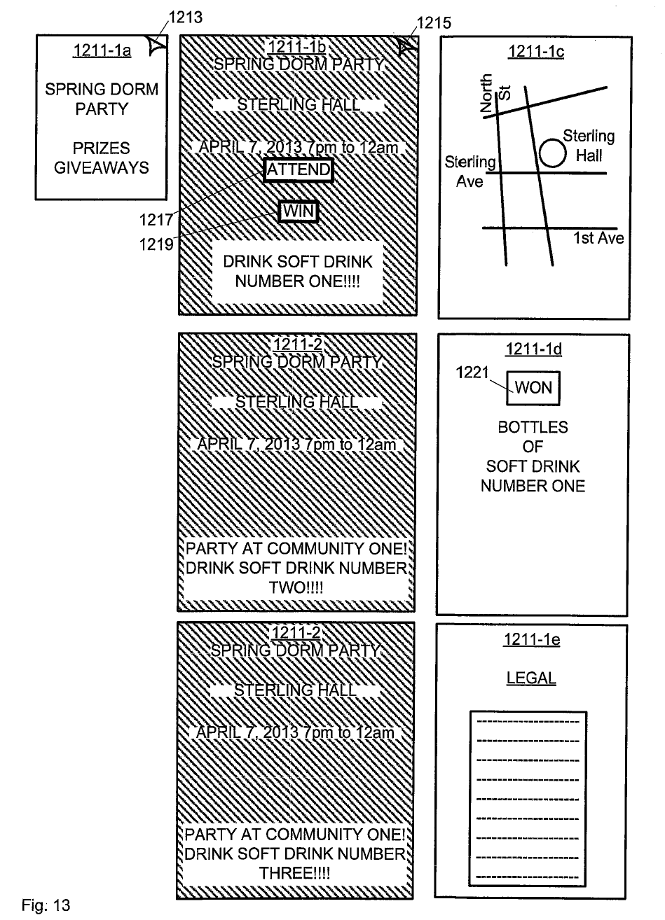

For example, attention is directed to FIG. 13, which depicts each of rendered versions 1211-1, 1211-2, 1211-3 of service data record 111-1. It is further assumed in FIG. 13 that service data record 111-1 comprises metadata associated with an event associated with community 119-1. The association of the event with a given community 119 can be provided in one or more of data record section 109 that is an element of service data record 111-1 and/or in a metadata field 603 that is in an element of service data record 111-1. For example, relationship metadata field 603-3 can be used to define a community 119 with which a data record section 109 is associated. As depicted in FIG. 13, rendered version 1211-1 is preferably a series of pages 1211-1a to 1211-1n. Each page 1211-1a to 1n has been populated with data associated with a first soft drink company (“DRINK SOFT DRINK NUMBER ONE!!!!”) and data associated with the event. The front page 1211-1a is a teaser page designed to attract attention of the user. If the user is interested, the user touches a page corner icon 1213 which will responsively flip the teaser page to a flip page 1211-1b, which will contain more detailed information of the event and the sponsor. If the user is not interested, the user touches a page corner icon 1215 which will redisplay the front teaser page 1211-1a and then the user is able to navigate through other rendered versions of other service data records 111.

If the user is interested, the user can scroll through a set of detail pages that are populated with data that provide a greater detail of information relating to the event and/or the sponsor. For example, page 1211-1c is a map of the location of the event, page 1211-1d provides details of the prize and how to claim the prize or give-away, and page 1211-1e provides details of the rules of the prize or give-away. Additionally, virtual buttons or hotspots 1217, 1219 and 1221 are provided to elicit user response. For example, hotspot 1217 elicits a user response if the user intends on attending the event. Hotspots 1219 and 1221 elicit a user response if the user wishes to win or claim a prize or coupon. It is important to note that each element of data that is provided on the page has analytic metadata field 603 associated therewith and it is thus possible to track not only the number of hits on the teaser page 1211-1a but also the number of hits on the flip page 1211-1b and detail pages 1211-1c-n as well as the number of “attends” and the number that claim the prizes.

Additionally, a link can be provided to existing social messaging sites, such as Facebook™, whereby a user can manually or automatically post a message that the user is going to the event and/or has claimed a prize or coupon.

Rendered version 1211-2 has been populated with data associated with a first soft drink company along with an indication that service data record 111-1 is associated with community 119-1 (“PARTY AT COMMUNITY ONE! DRINK SOFT DRINK NUMBER TWO!!!!”). Similarly, rendered version 1211-3 has been populated with data associated with a first soft drink company along with an indication that service data record 111-1 is associated with community 119-1 (“PARTY AT COMMUNITY ONE! DRINK SOFT DRINK NUMBER THREE!!!!”).

The metadata for providing an indication of an association of a service data record 111-1 can be provided by content manager 113, for example as an element of community data 120 and/or processor 220 can be configured to populate field 1004-1 with an indication of the association.

In any event, rendered versions 1211 of service data record 111-1 can be stored at server 101, as also depicted in FIG. 12 once generated by compositing engine 115.

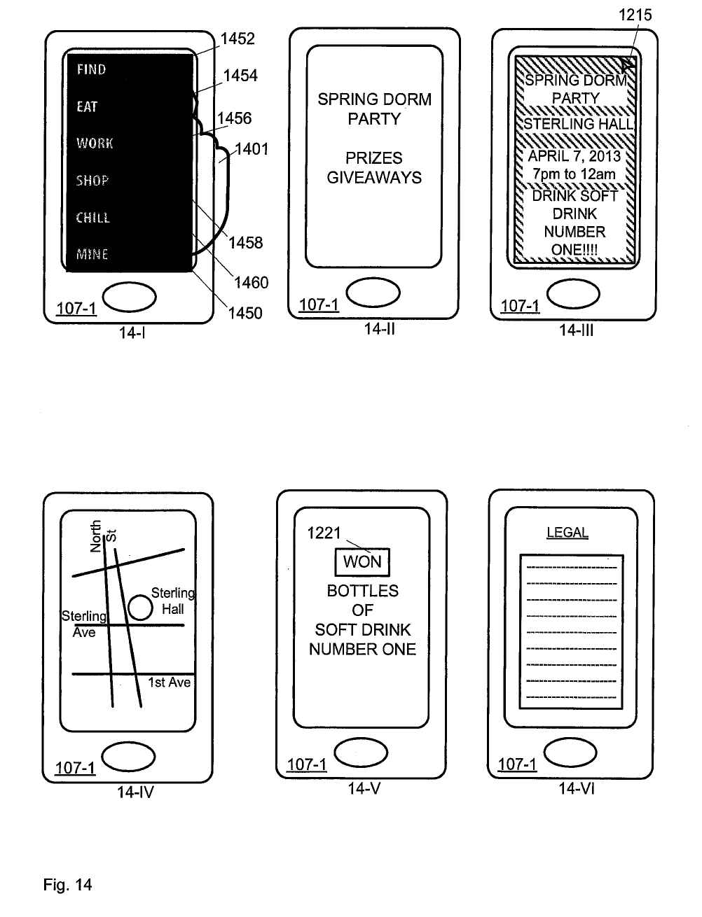

Attention is next directed to FIG. 14, which depicts views 14-I, 14-II that can be provided at a user device 107-1 associated with community 119-1. Specifically, view 14-I depicts a GUI of application 550 rendered at display 526 of user device 107-1. However view 14-I can be provided at any of user devices 107, and it is appreciated that user device 107-1 is depicted merely as a non-limiting example.

Referring to FIG. 14, a mobile dashboard 1450 is displayed on a user device 107-1. The dashboard 1450 comprises a plurality of hotspots 1452, 1454, 1456, 1458, 1460, and 1462. In the present example, hotspot 1452 is labeled FIND, hotspot 1454 is labeled EAT, hotspot 1456 is labeled WORK, hotspot 1458 is labeled SHOP, hotspot 1460 is labeled CHILL and hotspot 1462 is labeled MINE. Dashboard 1450 may contain any number hotspots but is preferably limited to minimize complexity and thereby maximize the users' experience.

A user merely touches or mouse clicks while the cursor is overtop of a particular hotspot to activate the first series of pages that are linked under the hotspot. A user can then utilize conventional gestures, such as left or right swipes to navigate between the front pages of each series of pages, up or down swipes to scroll through a subsequent page of a series of pages, and finger pinching and unpinching to magnify or demagnify the contents of a page.

Pages having a common theme are grouped under each of the FIND hotspot 1452, WORK hotspot 1456, SHOP hotspot 1458 and CHILL hotspot 1460. As is now apparent to those skilled in the art, and in particular to those in the marketing industry, the possibilities of content for each of pages are limitless. However, to limit the time required to peruse pages under each of the topics, it is desirable to limit the number of first series of pages to 10.

The MINE hotspot 1462 responsively displays a series of user utilities and tools, such as web applications, calendars, web links, social media (Facebook™, Twitter™, Instagram™, and Pinterest™) and an account manager.

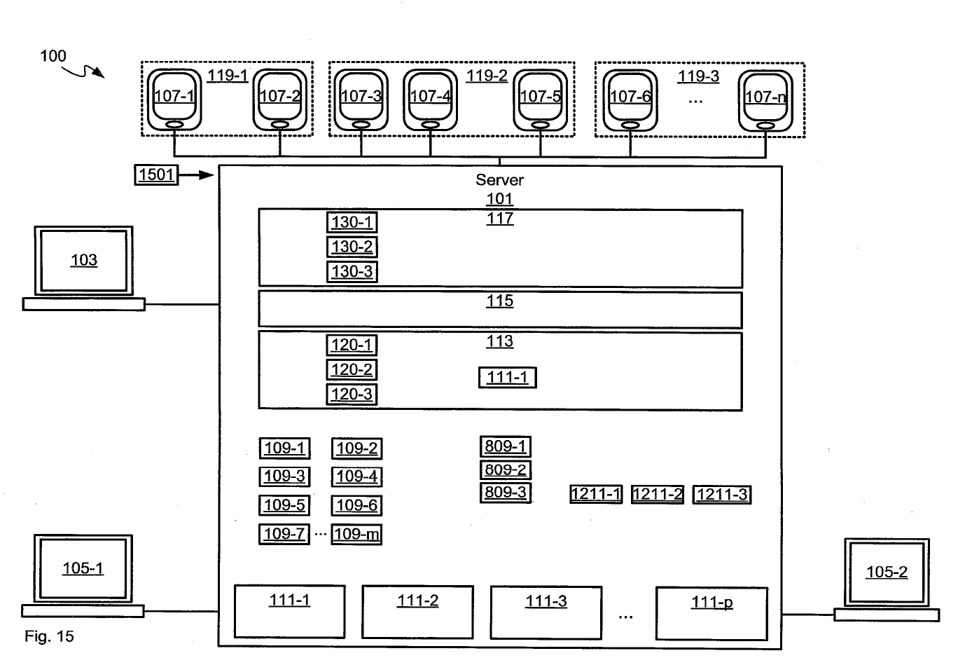

While each of the selectable options is provided with a natural name, receipt of input data at input device 528 indicating a selectable option causes a request for rendered versions of service data records 111 associated with the selectable option. The association between the selectable options and the rendered versions of service data records 111 can be stored in data 130. Hence, for example, when the selectable option “Find” is selected (e.g. via a finger of a hand 1401 of user, presuming input device 528 comprises a touch screen), user device 107-1 transmits a request 1501 to server 101 for rendered versions of service data records 111 that are associated with both the selected option “Find” and with community 119-1. Hence, request 1501, depicted in FIG. 15 (substantially similar to FIG. 12, with like elements having like numbers), comprises data identifying selected option “Find”, and one or more of user device 107-1 and community 119-1. Regardless, server 101 is generally configured to determine with which community 119 request 1501 is associated.

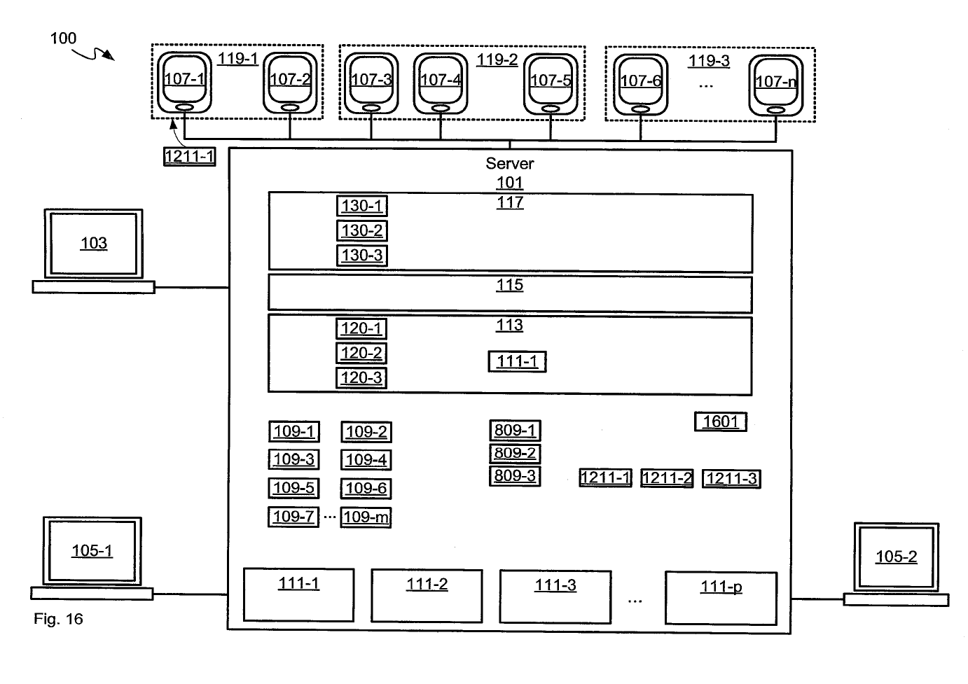

Once server 101 receives request 1501, and determines which community 119 request 1501 is associated with, processor 220 processes the associated data 130 of filter 117, in this example data 130-1, to determine which rendered versions of service data records 111 to transmit to user device 107-1. For example, assuming that data 130-1 defines that rendered version 1211-1 is associated with community 119-1, and further associated with the selectable option “Find”, server 101 transmits rendered version 1211-1 to user device 107-1, as depicted in FIG. 16 (substantially similar to FIG. 15, with like elements having like numbers). User device 107-1 then provides rendered version 1211-1 at display 526, as depicted in view 14-II of FIG. 14.

With further reference to FIG. 16, processor 220 can further store a record 1601 of access of rendered version 1211-1; however, it is appreciated that record 1601 can be stored only when analytic metadata field 603-1 of service data record 111-1 indicates that a record of access of rendered version 1211-1 should be stored.

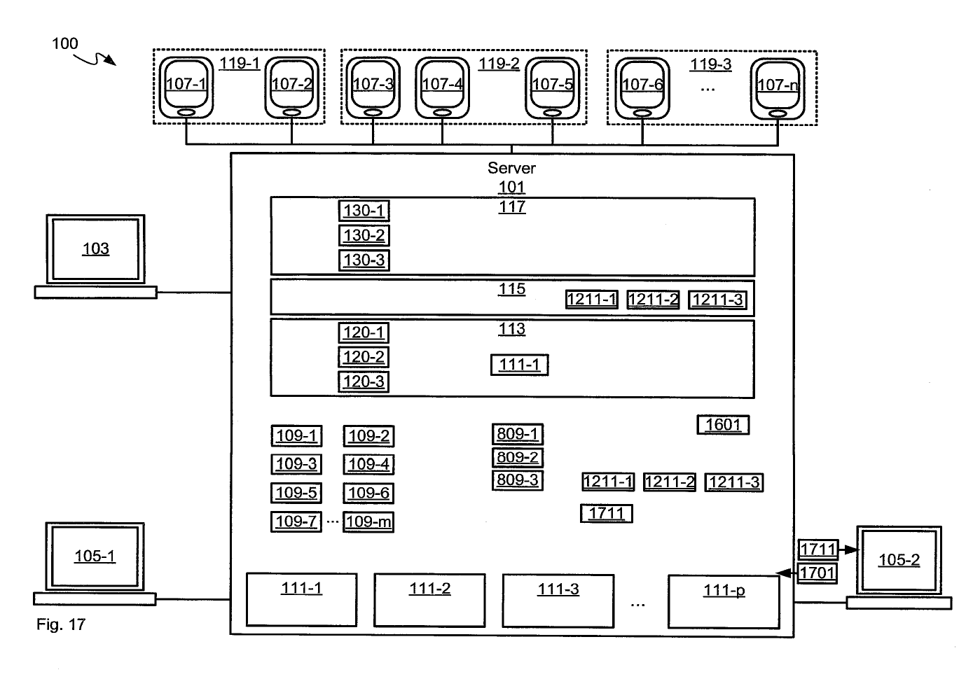

Attention is next directed to FIG. 17 (substantially similar to FIG. 16, with like elements having like numbers), which depicts publishing device 105-2 requesting a rendered version 1711 of service data record 111-2. It is assumed in FIG. 17 that rendered version 1711 of service data record 111-2 has been previously generated, similar to rendered versions 1211, and that service data record 111-2 comprises data record sections 109 and/or analytic metadata fields 603 for one or more of analyzing activity associated with the interactions between one or more of service data records 111 and one or more of user devices 107; analyzing activity associated with interactions between one or more service data records 111 and one or more user devices 107 based on analytics provided in one or more of the metadata fields 603.

It is further assumed in FIG. 17, that publishing device 105-2 is associated with a community 119 of advertisers in system 100. In other words, for example, publishing device 105-2 can be associated with one of the soft drink companies referred to previously, such as the first soft drink company.

It is yet further assumed that service data record 111-2 has been configured by publishing device 105-2 to provide data regarding accesses of service data records 111 which, in non-limiting examples, comprise advertising associated with the first soft drink company.

It is yet further appreciated that each of the aforementioned associations and analytics can be configured using metadata fields 603, as described above.

In an event, publishing device 105-2 can transmit a request for rendered version 1711 of service data record 111-2, which after appropriate security confirmation is returned to publishing device 105-2.

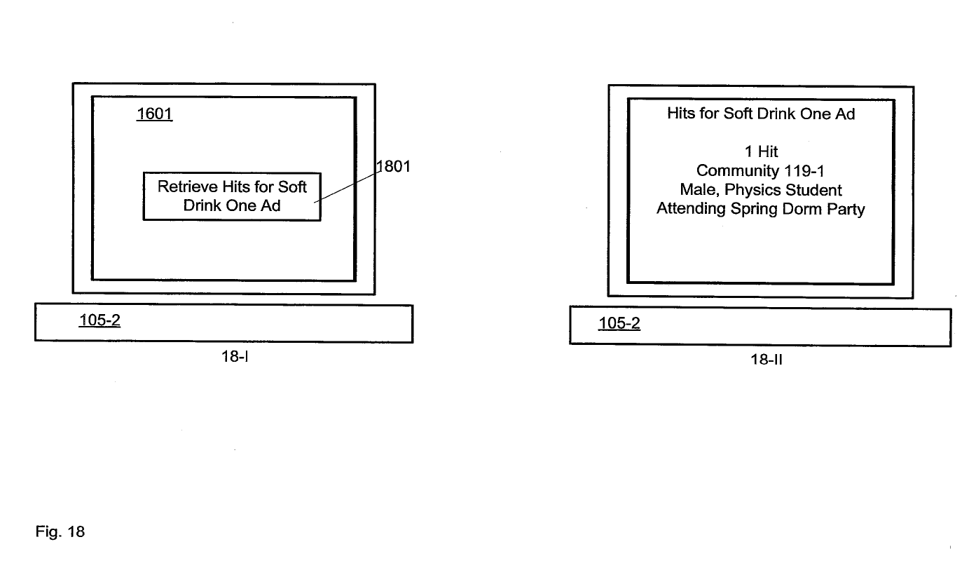

Attention is next directed to FIG. 18, which depicts views 18-I, 18-II that can be provided at a publishing device 105-1. Specifically, view 18-I depicts a GUI of rendered version 1711 of service data record 111-2 rendered at display 426 of publishing device 105-1. However view 18-I could alternatively be provided at any of user devices 107, and/or any other device that has permission to access and/or edit service data record 111-2; indeed it is appreciated that publishing device 105-2 accessing service data record 111-2 (and/or rendered version 1711 thereof) is depicted merely as a non-limiting example.

In any event from view 18-I it is apparent that rendered version 1711 comprises a virtual button 1801 for retrieving data indicative of a number of times advertising data associated with an entity operating publishing device 105-2 (and the like) has been accessed. Virtual button 1801 can be configured using a data record section 109 that comprises a virtual button corresponding to virtual button 1801, for example in input data 601. Further, service data record 111-2 comprises an analytic metadata field 603 for retrieving data indicative of a number of times advertising data associated with an entity operating publishing device 105-2 (and the like) has been accessed, for example record 1601.

View 18-II depicts a GUI rendered at publishing device 105-2 when virtual button 1801 is actuated and analytics in the associated analytic metadata field 603 retrieve data 1601, and any other records of accesses of the advertising data associated with an entity operating publishing device 105-2 (and the like). The analytics can include requesting a database lookup and the like of record 1601 based on data encoded in the associated analytic metadata field 603, which can define the data to be retrieved (e.g. an identifier of advertising data, which can also be stored in record 1601). It is apparent from view 18-II that only one access has been recorded, and further details of the access are provided in view 18-II. Format and/or content of the output of the analytics provided in view 18-II can also be configured via a metadata field 603 associated with service data record 111-2.

Further from view 18-II it is apparent that details of the access can include, but is not limited to, demographics of a user of user device 107-1, as well as an indication of the context in which the user viewed the advertising data (e.g. the text “Attending Spring Dorm Party” indicates that the user viewed the advertising in field 1001-4 of rendered version 1211-1).

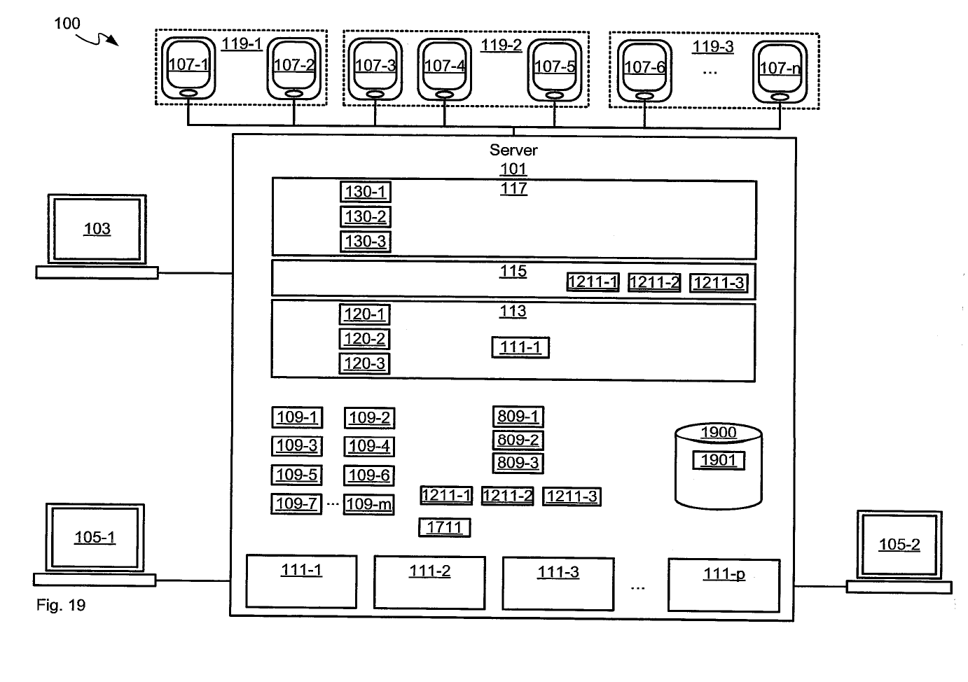

While the above example has been described with regards to a single record 1601, attention is next directed to FIG. 19, which is substantially similar to FIG. 18, with like elements having like numbers. However, in FIG. 19, server 101 further comprises a database 1900 of data 1901 of accesses of service data records 111 (and/or rendered versions thereof) and/or any data defined by analytic metadata fields 603 of service data records 111 and/or data record sections 109 thereof. It is appreciated that database 1900 is built up over time, for example from records similar to record 1601; indeed, data 1901 can comprise record 1601.

Hence, an entity wishing to advertise in system 100 can access database 1900 via a suitable service data record 111 to determine who has seen associated advertising data, what events they might attend, and/or what businesses they might frequent, and/or what their purchasing preferences might be.

Indeed, it is appreciated that while, present examples are described with regards to service data record 111-1 being associated with an event, in other implementations, service data records 111 associated with businesses, advertising, coupons, job searches, shopping, games, and the like can be transmitted to user devices 107 as described above. Further service data records 111 can comprise virtual buttons to, for example, redeem coupons, request further information regarding a business, service and the like, and/or to register a user device 107 with system 100 and/or to sign into system 100.

It is yet further appreciated that system 100 can be used for social networking. For example, a service data record 111 can be configured to search for and identify other users of user devices 107, and yet further service data records 111 can be configured to relay messages from a given user device 107 to one or more other user devices 107. For example, some service data records 111 can include a “Share” virtual button for transmitting a rendered version of a service data record 111 to from a given user device 107 to one or more other user devices 107.

While system 100 is depicted as a closed system (e.g. there is no depicted access to other communication networks), present implementations are not so limited, and system 100 can be in communication with at least one communication network including, but not limited to, the Internet, such that, in addition to service data records 111 (and/or rendered versions thereof), browser data and the like can be retrieved via the at least one communication network, for example as an action implementable when a virtual button, and the like, is actuated at service data record 111 and/or a rendered version thereof.

Hence, present implementations provide data record sections, configured with metadata fields, that be assembled into data records, which can in turn be provided to user devices. Hence, once development of the data record sections and/or metadata fields occurs, the data record sections and metadata fields can be mixed and matched depending on the desired functionality of the data record to be assembled and/or the type of information the data record is meant to convey. Such “shuffling” of data record sections and metadata fields, which can be likened to shuffling cards, greatly simplifies the process of developing content for access by user devices, and furthermore allows for customization of such content using administrative metadata. Further editing of such content is simplified as a user of a publishing device that is populating such content has no need to learn a programming language; rather, simple data entry and/or graphical manipulation of representations of data record sections and/or metadata fields can be used to produce the content. Similar comments apply to a user of an administrative device.

Furthermore, by storing data records (i.e. the content) and records of accesses thereof, on a common server (and/or a group of associated common servers), marketing data is easily collected and social networking is simplified.

One of the principal advantages of the present invention is that data can be added, edited and revised, and thus the displayed pages, without the need to change the code. For example, if the sponsor of the event wishes to add additional prizes for the event, the sponsor needs only to add, edit and revise the data as desired. The sponsor need not utilize a programmer to add new content. The database will recognize that new data has been entered and will undertake the required steps, including rendering and saving, to produce a new page for viewing.

Additionally, if high resolution images have been inputted and stored in memory, the pages that are rendered for the mobile user device 107 could also be printed in a large poster format. For instance, page 1211-1a of FIG. 12 with the exclusion of the icon 1213, could be printed in a large format and then displayed near and about the location of the event for advertising purposes. Further, the same pages could be utilized in digital signage.

The mobile user devices 107 may be also provided with an electronic money function. The money function enables the user to pre-order and pre-pay for items, such as meals, redeem pre-paid affinity cards or gift cards and also redeem digital coupons. The user device 107 displays a secure page that is scanned at the cash register and the purchase price is automatically deducted from the user's account.

Those skilled in the art will appreciate that initial implementation of the present invention requires a significant quantity of data to be entered. In order to allow persons not familiar with the system 101 and the templates 809, an Excel™ spreadsheet can be provided to enter data. A simple script can be provided to extract the data and upload the data to the server 101 in the proper format together with fields 603 being populated with appropriate metadata.

Those skilled in the art will appreciate that in some implementations, the functionality of system 100 can be implemented using pre-programmed hardware or firmware elements (e.g., application specific integrated circuits (ASIC s), electrically erasable programmable read-only memories (EEPROMs), etc.), or other related components. In other implementations, the functionality of system 100 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other communication interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative implementations and modifications possible, and that the above examples are only illustrations of one or more implementations. The scope, therefore, is only to be limited by the claims appended hereto.

1. A system for enabling and populating content for marketing services in a social networking environment, comprising:
a memory having a first data structure to store a plurality of data record sections, wherein each data record section includes a plurality of data fields and a plurality of metadata fields, the memory having a second data structure to store a plurality of service data records;
an administrator device for configuring the data record sections to generate relationships and interdependent integrity rules governing entry, content, access, association, functionality and appearance of input data received in each of the plurality of data fields and for generating associated metadata corresponding to said relationships and interdependency rules and storing the associated metadata in a plurality of metadata fields, the administrator device also for generating a template for entering input data into the plurality of data fields and for generating a combination of templates for selecting data record sections to produce a desired functionality of a marketing event, and wherein the administrator device identifies a community and a publishing device associated with the community, the administrator device configuring the publishing device to access the combination of the templates for entry of input data to add content to the data record sections, select data record sections and generate the plurality of service data records for developing content and the desired functionality for access by users of the community, and edit, add and revise the content, functionality and user access of the community, wherein the publishing device is enabled through data entry to create, edit, revise, publish and distribute the marketing event in a social networking environment to the community;
a communication interface connected to the memory, the administrator device via a network, and a user device via the network, the communication interface for receiving, from the administrator device via the network, the input data, a request for a service data record from the plurality of service data records, and an identifier associated with a user, the communication interface further configured to receive a response from the user device corresponding to user interaction with a series of pages, and transmit a preset response of the service data record; and
a processor connected to the memory and the communication interface, the processor configured to use the input data in the memory and associated metadata to select a subset of data record sections to generate a service data record wherein the processor is also configured to render service data records including the series of pages, a first teaser page, and a detail page detailing respective data of the first teaser page, and automatically add respective associated metadata into an associated metadata fields of the service data record, the processor configured to confirm that the request is from a member of the community using the identifier and that the request for service data records includes only data record sections associated with the community, and to transmit a rendered version of the service data record corresponding to the request to the user device via the communication interface to display at least a corresponding one of the series of pages on the user device, the processor configured to recognize whether the input data has been added to or the input data has been edited and revised and to produce a replacement page for the series of pages in response to the input data, and when a request for the service data record is received from a user device, the processor is configured to render and transmit the rendered version of the service data record incorporating the replacement page.

2. The system as claimed in claim 1, wherein said administrator device configures said associated metadata to include analytics metadata.

3. The system as claimed in claim 2, wherein said analytics metadata is for recording activity associated with interactions between the service data record and one or more of said user device accessing the service data record via the communication interface.

4. The system as claimed in claim 3, wherein said analytics metadata is for analyzing an activity associated with the interactions to generate associated advertising data.

5. The system as claimed in claim 4, wherein said analytics metadata is for storing the associated advertising data in the memory, wherein said administrator device configures the publishing device to access said associated advertising data.

6. The system of claim 1, wherein said processor further comprises a content manager configured to control content, appearance and assembly of the rendered version of the service data records.

7. The system of claim 6, wherein said processor further comprises a compositing engine for producing the rendered version of the service data records.

8. The system of claim 1, further comprising a virtual button for receiving the input data.

9. The system of claim 1, further comprising the series of pages is utilized in digital signage.

10. The system of claim 1, wherein the administrator device is to configure the publishing device to limit access to a demographic.

11. The system of claim 1, wherein the plurality of service data records is shared over a social network.

12. The system of claim 1, wherein the one of the series of pages is a secure page to carry out a financial transaction.

13. A method of enabling and populating content for marketing services in a social networking environment, the method comprising:
storing a plurality of data record sections in a first data structure of a memory, wherein each data record section includes a plurality of data fields and a plurality of metadata fields, the memory having a second data structure to store a plurality of service data records;
configuring, with an administrator device, the data record sections to generate relationships and interdependent integrity rules governing entry, content, access, association, functionality and appearance of input data received in each of the plurality of data fields;
generating associated metadata corresponding to said relationships and interdependency rules and storing the associated metadata in a plurality of metadata fields, a template for entering input data into the plurality of data fields, and a combination of templates for selecting data record sections to produce a desired functionality of a marketing event;
identifying a community and a publishing device associated with the community, the publishing device to access the combination of the templates for entry of input data to add content to the data record sections, select data record sections and generate the plurality of service data records for developing content and the desired functionality for access by users of the community, and edit, add and revise the content, functionality and user access of the community, wherein the publishing device is enabled through data entry to create, edit, revise, publish and distribute the marketing event in a social networking environment to the community;
receiving the input data, a request from a user device for a service data record from the plurality of service data records, and an identifier associated with a user, a response corresponding to user interaction with a series of pages, wherein the request is confirmed to be from a member of the community using the identifier, and wherein the request for the service data record includes only data record sections associated with the community;
transmitting a preset response of the service data record;
selecting a subset of data record sections to generate a service data record use the input data in the memory and associated metadata;
automatically adding respective associated metadata into an associated metadata fields of the service data record;
rendering service data records including the series of pages, a first teaser page, and a detail page detailing respective data of the first teaser page; and
transmitting a rendered version of the service data record corresponding to the request to the user device via a communication interface to display at least a corresponding one of the series of pages on the user device, wherein a processor is configured to recognize whether the input data has been added to or the input data has been edited and revised and to produce a replacement page for the series of pages in response to the input data, and when a request for the service data record is received from a user device, the processor configured to render and transmit the rendered version of the service data record incorporating the replacement page.

14. The method of claim 13, further comprising recording, using analytics metadata, activity associated with interactions between the service data record and one or more of said user device accessing the service data record via the communication interface.

15. The method of claim 14, further comprising analyzing an activity associated with the interactions to generate associated advertising data using the analytics metadata.

16. The method of claim 15, further comprising configuring the publishing device with the administrator device to access said associated advertising data based on the analytics metadata.

17. The method of claim 13, receiving the input data comprises receiving input via a virtual button.

18. The method of claim 13, further comprising generating digital signage using the series of pages.

19. The method of claim 13, further comprising limiting access of the publishing device to a demographic.

20. The method of claim 13, further comprising sharing the plurality of service data records over a social network.
